(19) United States
(12) Patent Application Publication
(10) Pub. No.: US 2016/0013827 A1
(43) Pub. Date: Jan. 14, 2016

(54) BATTERY FOR EXTENDING MOBILE COMMUNICATION DEVICE FUNCTIONALITY

(71) Applicant: SMK CORPORATION, Tokyo (JP)

(72) Inventors: Emil HUBINAK, Piest'any (SK); Miroslav FLOREK, Bratislava (SK)

(21) Appl. No.: 14/770,660

(22) PCT Filed: Feb. 27, 2014
(86) PCT No.: PCT/IB2014/059293

§ 371 Date: Aug. 26, 2015

(30) Foreign Application Priority Data
Feb. 28, 2013 (SK) PP 50005-2013

(51) Int. Cl. H04B 1/3818; H01M 10/42

(52) U.S. Cl. CPC H04B 1/3818; H01M 10/4257; H01M 2220/30

(57) ABSTRACT

The battery (1) of a mobile communication device, especially a mobile phone, has at least one slot (2) for insertion an additional element and has a motion and/or shock sensor (3), and the electric power supply of the slot (2) is connected to the battery (1) via a switch (6) that is activated by a motion and/or shock sensor (3). The switch (6) is timing and connects the slot (2) to voltage for the set time during which the length of the switch (6) closure can be extended by the activity followed by an additional component. The additional element will particularly be the removable memory card (4) of SD or microSD format, or the removable card (5) of SIM format and the slot (2) will have an appropriate interface. The battery can also have a Bluetooth module (7), and the Bluetooth module (7) is adapted to communicate with a host mobile communication device. The removable memory card (4) or the removable card (5) of SIM format can have an antenna to create an additional contactless communication connection, favorably of NFC type. The larger antenna (8) can be wound up directly on the body of the battery (1).

### FIELD OF THE INVENTION

The present invention relates to a battery that can additionally extend functionality of a mobile communication device, especially a mobile phone, without affecting other hardware. It can involve an extension on a new slot for a removable memory card, SIM card or for an additional contactless NFC/RFID communication channel creation. The solution is designed primarily for payment applications implemented with the help of a mobile communication device. In principle, however, new components and new connection to the battery can also be used for other functions.

### PRESENT TECHNOLOGY STATUS

There are known such solutions, which allow an additional communication channel creation, especially of NFC type in structures of existing mobile phones even if the mobile phone itself does not have a slot for insertion an additional component, which could include NFC antenna and an appropriate controller. For mobile phones without a user-accessible slot, there exist, for example, additional modules with NFC antenna. Those are different panels, covers that are inconvenient and increase the thickness of the mobile phone.

From other technical solutions are known mobile phone batteries that contain in themselves the additional slot for the removable card of SD or SIM format, for instance. These solutions, as for example CN1373623A, FR2811185 (A1), GB2377825 (A), within the battery, create a room for the slot in which is inserted the removable card, but for the slot control and power supply it is necessary to create needed contact fields already in the mobile phone design. Such solutions are therefore not applicable for already-manufactured mobile phones wherein we want to achieve the update additionally.

Similarly, unusable approach can be seen in solutions when a contactless communication channel antenna is created on the battery and, however, the new battery requires also new, additional contacts for connection to the mobile phone (e.g. CN101009506A).

Desired is the kind of technical solution that will make possibilities to update a mobile communication device, especially a mobile phone with the removable battery replacement, without requiring other hardware changes in the mobile communication device. The additional element in the battery should have the ability to communicate with the actual host mobile communication device.

### SUBJECT MATTER OF THE INVENTION

The mentioned shortcomings are substantially eliminated by the battery for extending the mobile communication device functionality, particularly the mobile phone, wherein the battery comprises at least one slot for insertion an additional component, the slot has relevant contact interface, and wherein the battery is removable according to this invention, which is characterized in that the battery includes a motion and/or shock sensor, and slot power supply is connected to the battery via a timer which is activated by the motion and/or shock sensor. The term slot power supply means particularly power supply of the slot controller itself. The term battery means any electric energy source for a mobile communication device, mainly rechargeable batteries known as a battery pack.

Mobile communication devices, such as mobile phones, PDA, tablets and the like, have a removable battery which is separated from other hardware components and, after removing the covers, can be replaced for another one of the same outer dimensions and same contact locations. However, if we do not want to change the hardware in other parts of the mobile communication device, which is in existing already-manufactured devices impossible, it makes no sense to add new contact fields to control the additional slot because these contacts would not have the anti-interface on the phone side. Inappropriate is also such a solution when the additional element inserted into the battery slot should be constantly powered, therefore connected to the battery ends, that would substantially reduce the battery life on the main mobile communication device functions. Even when powered off or removed the battery, the power supply to the slot and the element embedded in it would not break. A new solution has been successfully invented, according to which an extra-added element slot is powered by the battery via a switch, which is activated by the motion and/or shock sensor. In consistent terminology, this sensor is called motion or shock sensor, but in fact it senses acceleration, i.e. change movement.

According to the intended function of the inserted additional element the time activation can be set to a different length. During this time (e.g. 1 min.), the switch activation can be extended if there is a supposed activity. For example, if the additionally inserted element provides NFC communication, during the set time, the removable card inserted in the battery slot will try to detect NFC communication channel. In case, there is no communication with the surroundings in the set time, the switch will interrupt to power the slot until the next instruction coming from the motion and/or shock sensor. In case, that during the set time there is a communication with the surroundings the power supply to the slot will continue until completion the already started applications.

In favorable configuration, the motion and/or shock sensor can be directional, in a set direction. The sensor can also evaluate a set number of repetitive movements. Those may be, for example, two wags in a direction parallel to the prevailing area of a mobile communication device. Standard manipulation with a mobile phone or its fall will not unnecessarily activate the power supply to the slot in the battery.

In terms of compatibility, it will be appropriate that the slot in the battery should have the format of SD and/or microSD and/or SIM card and/or ISO/IEC 7810 and/or ISO/IEC 7816. Referred to the mentioned solution, by inserting a new battery according the present invention, we can create for example microSD slot also in devices that do not have any SD slots (e.g. iPhone, the iPhone is a trademark of Apple Inc. and the applicant is not connected with the trade mark proprietor).

If is needed that the mobile communication device should communicate with the slot and a respective element embedded in it even beyond the turn on/turn off using specific motion, the battery can be equipped with Bluetooth communication element that is connected to the battery slot. The term Bluetooth means, in particular, wireless communication standard in the 2400-2480 MHz band, in general, for the purposes of the present invention is needed to understand that the Bluetooth is any wireless communication other than the NFC channel which is to be created within the battery. Essentially, all of the mobile communication devices have Bluetooth communication channel in order to connect an external device. In the solution according to the present invention, however, the Bluetooth can be used to communicate with the internal part of the mobile communication device, that is, with the battery with the slot. In the existing mobile communication device, new contact interface for the battery with additional contacts cannot be created, but the described insertion of a Bluetooth module to the battery will solve this problem. It will also be favorable if the Bluetooth module is activated via the motion and/or shock sensor. They may be of the same sensor and the same switch as is used to activate the power supply to the slot. In principle, the Bluetooth module can be activated always with activating the power supply to the slot, but in a different connection, Bluetooth can be activated separately (without activating the slot) with an appropriate motion gesture, for example four rocking motions.

In favorable configuration, the battery will include the microSD slot, in which is the removable microSD memory card. On it, there will be in addition to the classic interface also SWP interface with two added contacts. On the removable memory card is also a miniature NFC antenna that is capable to emit the sufficient electromagnetic field across battery covers. In favorable configuration, the removable memory card may also have at least one secure element. In purpose to personalize the removable memory card can be created additional contacts on its surface, for example five additional contacts from contacts of C1 a C8 according to ISO 7816.

In the described design, the battery will also have the SD controller with the Bluetooth module. After agreed gesture, the motion sensor activates a timer, which revives the SD controller and the removable memory card begins to power, which raises a preparation for payment application on the removable memory card. The antenna on the removable memory card tries to establish communication with the NFC reader of the POS nearby. To transfer data between the removable memory card and the mobile communication device itself the Bluetooth module is used, allowing that the mobile communication device display can be used as GUI for the current payment application.

In some applications the antenna within the battery is required to be able to work in reader mode, so it will power the passive components in the mobile communication device surrounding via the electromagnetic field. In such a case, it is preferable if the battery is provided with its own larger antenna wound up on the battery so that the loops are winding around the battery core, thus they are passing across the neighboring and opposing areas of the battery. On at least one area, the antenna coil is separated from the battery core with a ferrite foil.

The large antenna winding the battery core and the miniature antenna on the removable memory card can cooperate alternatively so that the large antenna will be activated only when the reader mode is required. In another setting, just a large antenna can always be preferably used, even if the microSD card with its own antenna is inserted into the slot.

The battery according to the present invention has universal usage; it extends the capability and functionality of existing mobile phones, even if they do not have their own SD slot. The battery, nevertheless, can work with already-developed microSD cards with its own antenna and secure element. This will also allow card issuers to personalize payment microSD cards or SIM cards in existing way and consequently they are used in updated mobile phones. The advantage is also a simple way of actuating the acceleration of applications with a motion gesture (Shake and Pay) when battery power is saved.

### BRIEF DESCRIPTION OF DRAWINGS

The solution is further explained with FIGS. 1 to 7. The used display scale and the ratio of individual components may not correspond to description in the examples and the scales and proportions cannot be interpreted as narrowing the scope of protection.

FIG. 1 shows the battery with a microSD card with one secure element in the capacity of an electronic purse. The battery power outputs are connected with external battery pack contacts permanently as in the actual design. Diagram in FIG. 1 indicates that the switch controls the power supply to the slot, or the controller slot, especially it controls the turn-off from the battery.

FIG. 2 depicts the battery with a microSD slot, SD controller and a Bluetooth module where the antenna is located on the microSD card.

FIG. 3 shows the microSD card with SWP contact interface, FIG. 4, then, the microSD card with SWP contact interface and with personalization contacts.

FIG. 5 depicts the battery with a microSD slot, SD controller and a Bluetooth module, where the antenna is located on the microSD card and the large antenna is wound up around the battery.

FIG. 6 is an example of a control motion to which is set an activation command from the motion sensor.

FIG. 7 provides an overview of the battery with a slot for inserting the card of SIM card format.

### EXAMPLES OF APPLICATION

### Example 1

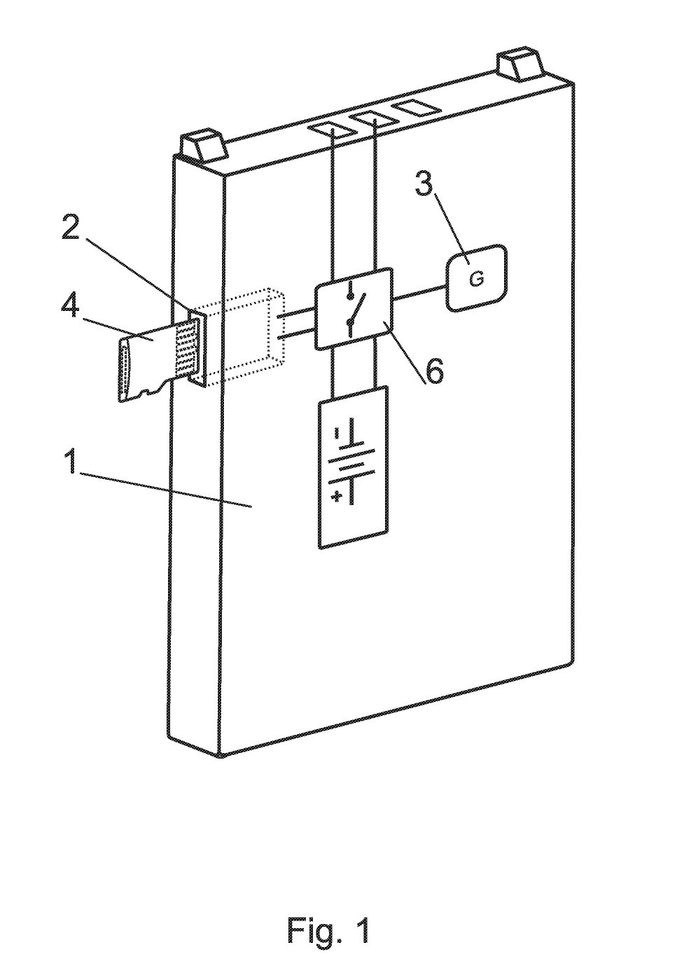

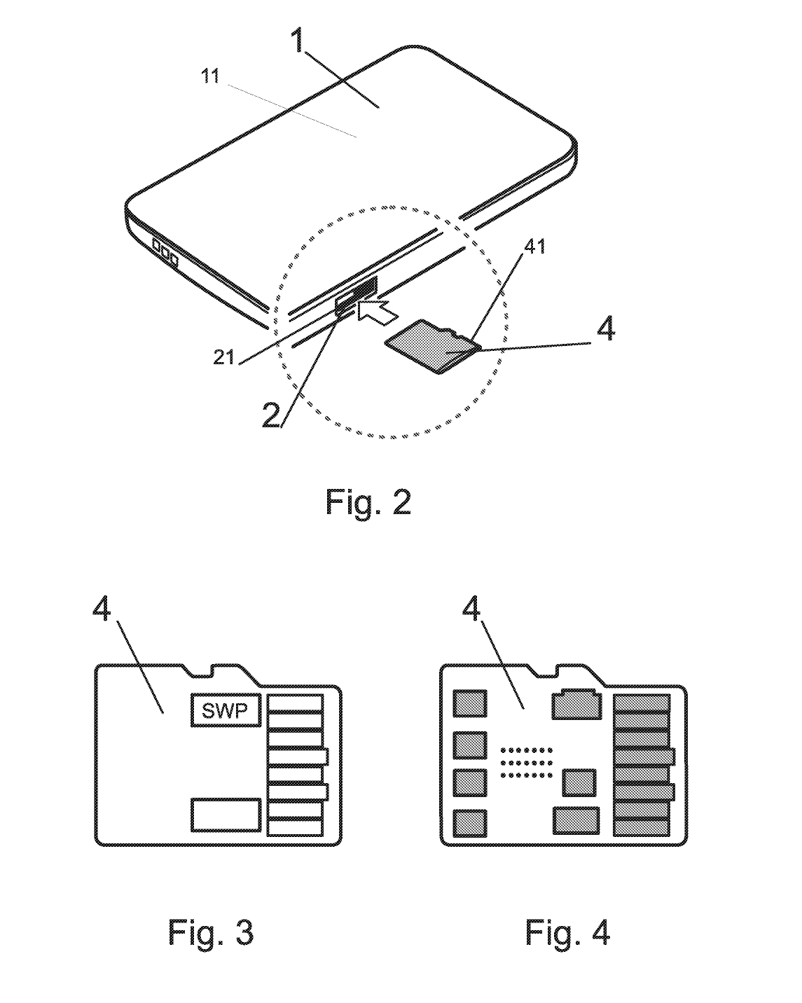

In this example, as shown in FIGS. 1 to 4 and 6, the battery 1 has a shape of flat body, which in its outer shape and size is equivalent to conventional battery 1 of respective mobile phone. A user can insert such a removable battery 1 into the mobile phone and give it new functionality. To the side edge of the battery is designed a slot 2 for the microSD card. A controller of the microSD slot 2 is connected and powered from the battery 1 via the switch 6 that is activated by a motion and/or shock sensor 3. The switch 6 after the signal from the motion and/or shock sensor 3 turns on the power to the microSD controller set for 60 seconds. The removable memory card 4 inserted in the slot 2 is activated and application starts up.

The battery 1 also has a Bluetooth module 7 connected to the microSD controller. It may be a simple microSD controller with Bluetooth interface.

On the removable memory card 4, there is a miniature NFC antenna, a smart card chip and a secure element. Thanks to the antenna the battery 1 gets the capability to communicate with unknown NFC readers, for example with POS terminal reader. In order that battery 1, particularly the microSD controller of the slot 2, and other additional elements of the battery 1 could communicate with the visiting mobile communication device, the battery 1 has the Bluetooth module 7, which is recognized by the visiting mobile communication device. The SD controller communicates with a mobile phone via the Bluetooth module 7. The switch 6 is activated under the direction of the motion and/or shock sensor 3 and also by transmitting activity caught on the antenna or on the Bluetooth module 7. These directions and activities actuate the power supply to the microSD controller or prolong the time of its power supply.

The motion and/or shock sensor 3 is directional and in the battery 1 is positioned to detect the acceleration in direction of the plane that is parallel to the largest area of the mobile phone. The control gesture evaluation is made in a way that two oscillating movements, like “shaking” according to FIG. 6, turn on the switch 6.

The battery 1 can upgrade any mobile phone with a new NFC card emulation function. This gives rise to the possibility of using mobile phone payment applications based on NFC IC microSD and even in phones without SD slot.

### Example 2

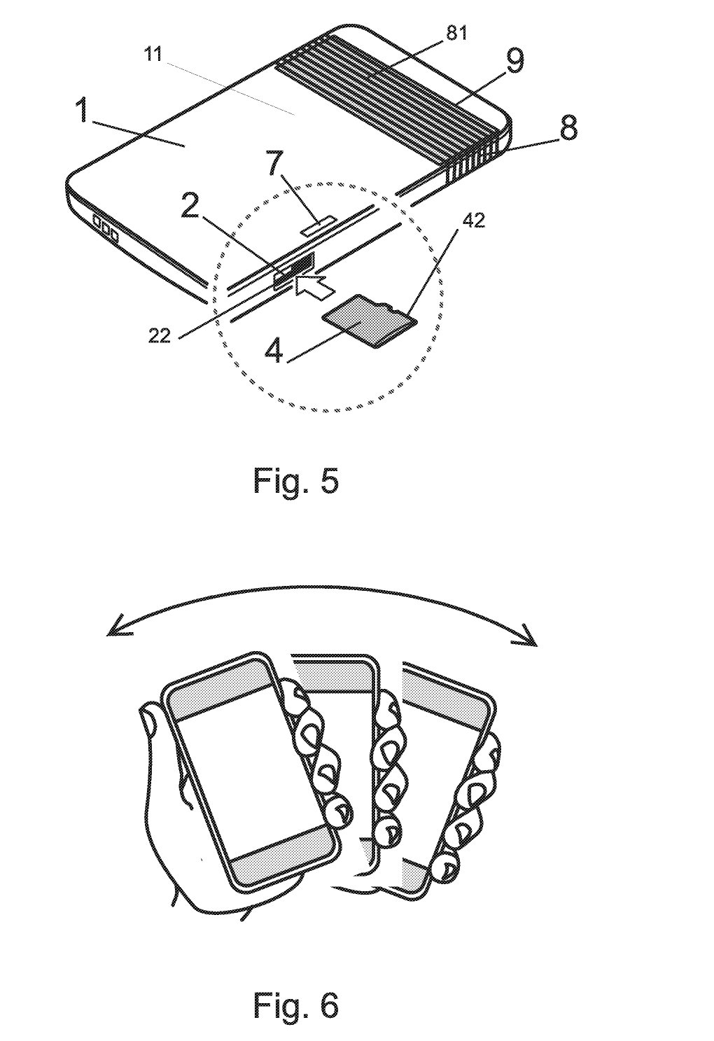

In this example, as shown in FIGS. 3 to 6, the battery 1, as in the previous example, has the slot 2 with an appropriate microSD controller, the Bluetooth module 7, the removable memory card 4 with its own miniature antenna and the SWP interface. The battery 1 contains NFC controller and SWP interface.

The battery 1 has also its own larger antenna 8, whose coil encircles the battery 1 core on the outside. Between the coil of the antenna 8 and the battery 1 body, on the one area, there is placed the ferrite foil 9.

The antenna 8 on the battery 1 body is used and involved by the reader mode, when the mobile phone activates passive NFC tags around the mobile phone.

The battery 1 makes possibility to create a direct communication channel between the smart card chip on the removable memory card 4 and the mobile phone. The solution is also compatible with Android NFC driver and usable are also removable memory cards 4 with SWP interface (FIG. 3) or removable memory cards with SWP interface and personalization contacts (FIG. 4) that are configured for processing according to ISO7816. Thanks to the antenna 8 an original phone without NFC element and also without a microSD slot is capable of working well also in NFC reader mode.

### Example 3

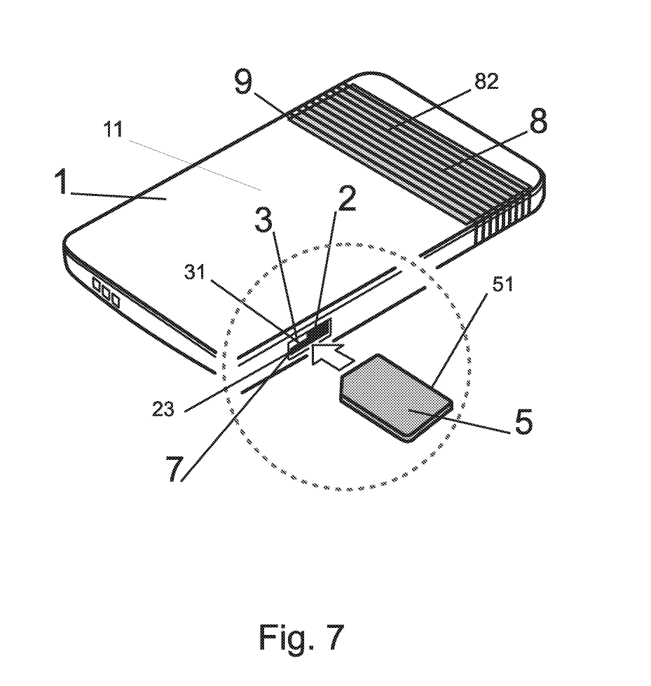

In this example, according to FIGS. 6 and 7, the battery 1 has a configuration similar as in the example 2, and thus with the larger antenna 8 on the battery 1 body. The slot 2 in this example is adapted for receiving a smart card chip in the format of the removable card 5 of SIM format. Also, this battery 1 is additionally able to create a full-valued NFC channel in the mobile phone.

### INDUSTRIAL APPLICABILITY

Industrial applicability is obvious. According to this invention, it is possible to produce, by industry and repeatedly, and use batteries that with unincreased number of external contacts can create a slot for an additional element, in particular in the form of a microSD card or SIM card.

### LIST OF RELATED SYMBOLS

1—battery
11—body of the battery
2—slot
21—SD controller with Bluetooth module
22—SD controller with Bluetooth module and NFC controller with SWP interface
23—NFC controller and Bluetooth module
3—shock and/or motion sensor
31—shock sensor
4—removable memory card
41—microSD card with embedded NFC antenna
42—microSD card with embedded NFC antenna and SWP interface
5—removable memory card of SIM format
51—Smart Card Chip in SIM format
6—switch
7—Bluetooth module
8—antenna
81—flat wire antenna coil
82—flat antenna coil
9—ferrite foil
NFC—Near Field Communication
RFID—Radio-Frequency Identification
POS—Point of Sale
SD—Secure Digital
GUI—Graphical User Interface
SIM—Subscriber Identity Module
SWP—Single Wire Protocol
ICC—Integrated chip card

1. A battery for extending mobile communication device functionality without requiring hardware changes in the mobile communication device, the battery comprising at least one slot adapted to accept an additional element, the slot having a contact interface for connection to the additional element, and a motion and/or shock sensor, an electric power supply of a controller of the slot being connected to the battery via a switch, and the motion and/or shock sensor being adapted to activate the switch, wherein the battery is removable from the mobile communication device.

2. The battery for extending mobile communication device functionality according to claim 1 wherein the switch is a timer switch.

3. The battery for extending mobile communication device functionality according to claim 2 wherein the timer switch is adapted to prolong the time of its power supply with regard to the activity of the additional element or other active element placed within the battery.

4. The battery for extending mobile communication device functionality according to claim 1 wherein the motion and/or shock sensor is directional and is adapted to evaluate a number of actuating gesture motions.

5. The battery for extending mobile communication device functionality according to claim 1 wherein the slot has the format of SD and/or microSD and/or SIM card and/or ISO/IEC 7810 and/or ISO/IEC 7816 and/or ICC card.

6. The battery for extending mobile communication device functionality according to claim 1 wherein the battery comprises a wireless communication module which is connected to the controller of the slot and which is powered by the battery via the switch, and the wireless communication module is adapted to communicate with a host mobile communication device.

7. The battery for extending the mobile communication device functionality according to claim 1 wherein the additional element inserted in the slot is a removable memory card or a removable card of SIM format and has an antenna to create an additional contactless communication link of NFC type.

8. The battery for extending the mobile communication device functionality according to claim 7 wherein the removable memory card or the removable card of SIM format has an SWP interface.

9. The battery for extending the mobile communication device functionality according to the claim 7 wherein the removable memory card or the removable card of SIM format has at least one secure element.

10. The battery for extending the mobile communication device functionality according to claim 1 wherein the mobile communication device has an antenna wound up in threads around a battery body with an axis of threads in a direction of a larger battery dimension, and at least one area of a coil of the antenna is separated from a battery core by a ferrite foil.

11. The battery for extending the mobile communication device functionality according to claim 10 wherein the antenna is connected to the controller of the slot.
